(19) United States
(12) Patent Application Publication
(10) Pub. No.: US 2017/0186104 A1
(43) Pub. Date: Jun. 29, 2017

(54) SYSTEMS AND METHODS FOR DELIVERING LOCATION-TRIGGERED OILFIELD CONTENT

(71) Applicant: WellDecide, Inc., Stafford, TX (US)

(72) Inventor: Mohammad Siddiqui, Stafford, TX (US)

(21) Appl. No.: 14/982,703

(22) Filed: Dec. 29, 2015

(51) Int. Cl. G06Q 50/02; G06F 3/0486; G06F 3/0481; G06Q 10/06

(52) U.S. Cl. CPC G06Q 50/02; G06Q 10/0637; G06F 3/0486; G06F 3/0481; G06F 2203/04803

(57) ABSTRACT

Systems, methods, and computer readable media for delivering location-triggered oilfield content. According to an embodiment, a user can obtain content that is customized to addressing a problem encountered at an oilfield located in a specified geographical location. The user can associate geographical identification metadata or geotags with the problem in order to access, share and leverage information pertaining to overcoming or resolving the problem. The user may also be able to search through a repository that contains content related to a plurality of problems encountered at the specific oilfield, receive recommendations for overcoming those specific challenges and acquire or solicit bids for equipment and services associated with the recommendations.

### BACKGROUND

The embodiments of the invention relate generally, to the field of computers, and more specifically, to delivering information and content for a specific oilfield location.

Companies, especially those in the oil and gas industry, exchange information and source goods and services from vendors across the globe. Computing devices and communication networks can be utilized to exchange content between the parties. However, despite the progress in technology, it is difficult to obtain solutions and services that are targeted to a specific oilfield location.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present invention relate to systems and methods for the delivery of location-triggered or location-enabled content for the oil industry. For instance, in one embodiment, using a geotagging system, a user can identify the unique challenges encountered at one or more oilfield locations to obtain associated location specific content on solutions, optimization techniques, equipment and services. The system uses geotagging algorithms to classify content on solutions, contextual lessons learned, best practices, equipment and services that may be responsive to the challenges encountered in the oilfield. This content may be stored in a repository. The content may be transmitted for display on a display of an electronic device in response to a query on a location specific oilfield problem. By providing timely, customized, contextual location specific content, the system can enable the user to improve oilfield related decision-making processes and to reduce any waste and inefficiencies in these processes. Additionally, the system can eliminate potentially expensive downtime due to untimely access to required oilfield equipment and services.

According to one embodiment, computer-implemented method for delivering location-triggered content comprises: creating, using a processor, a digital tag for a requirement associated with a geographical location, wherein the digital tag includes information associated with the requirement; associating geographical identification metadata with the digital tag; and dynamically displaying digital content responsive to a deployment of the digital tag at the geographical location. The method further involves displaying a digital map. One or more oilfields located at the geographical location may be automatically displayed on the digital map. The digital tag information further comprises information associated with the one or more oilfields. The requirement may be an oilfield requirement. The oilfield requirement may be selected from the group consisting of a challenge task encountered in at least one of the oilfields, an optimization technique for at least one of the oilfields, one or more oilfield equipment and/or services required to resolve the challenge task or to implement the optimization technique, and combinations thereof. The deployment of the digital tag may involve dragging and dropping the digital tag at map coordinates associated with at least one of the oilfields. The map coordinates may be previously determined and/or may be dynamically determined. The method further involves analyzing, using the computer processor, the information associated with the challenge task to deliver the digital content, wherein the digital content is customizable for resolving the challenge task and implementing the optimization technique. Implementing the optimization technique comprises dynamically presenting a recommended solution, a general technology best practice, a best practice for the geographical location and a lesson learned.

The method further involves implementing, using the processor, a feedback mechanism for delivering information associated with a viability of the displayed digital content. The method further comprises displaying predetermined information on a feedback provider. The predetermined information may include the feedback provider's job title and years of oilfield experience. The digital content may be displayed in a first area of a display device. Information on the one or more oilfield equipment and/or services may be displayed in a second area of the display device. The method further involves dynamically determining whether the one or more oilfield equipment and/or services are available for acquisition in the geographical location. The method further comprises facilitating inputting of the information on the one or more oilfield equipment and/or services. A bidding interface for the acquisition of the one or more equipment and/or services may be provided. The bidding interface may be integrated with a vendor messaging interface and a vendor payment interface.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of embodiments of the present disclosure without limitation to the claimed subject matter.

### BRIEF DESCRIPTION OF THE DRAWINGS

FIG. 1 is a diagrammatic view of a system for delivering geotagged oilfield content according to one embodiment.

FIG. 2 illustrates a method for delivering location-triggered oilfield content according to an embodiment.

FIG. 3 illustrates a method for creating a geotagged requirement according to an embodiment.

FIG. 4A illustrates a method for delivering location-triggered oilfield content according to an embodiment.

FIG. 4B illustrates an exemplary display for identifying a location of the oilfield(s) according to an embodiment.

FIG. 4C illustrates an exemplary display for a challenge log according to an embodiment.

FIG. 4D illustrates an exemplary display for adding a digital pin or tag according to an embodiment.

FIG. 4E illustrates an exemplary display for dragging the digital pin or tag to desired map coordinates according to an embodiment.

FIG. 4F illustrates an exemplary display for a user interface for identifying and geotagging a challenge task according to an embodiment.

FIG. 4G illustrates an exemplary display for geotagged solutions associated with a challenge task and related geotagged equipment and services according to an embodiment.

FIG. 4H illustrates an exemplary display for adding a new solution according to an embodiment.

FIG. 4I illustrates an exemplary display for geotagged solutions associated with a challenge task and related geotagged equipment and services in an expanded view according to an embodiment.

FIG. 5 illustrates an exemplary method for delivering location-triggered oilfield content according to an embodiment.

FIG. 6A illustrates an exemplary method for enabling vendors to deliver location-triggered requirements at an oilfield location according to an embodiment.

FIG. 6B illustrates an exemplary display for a vendor or service provider to identify a location of the oilfield(s) it services according to an embodiment.

FIG. 6C illustrates an exemplary display for adding a new equipment or service according to an embodiment.

FIG. 6D illustrates an exemplary interface for geotagged equipment and services according to an embodiment.

FIG. 6E illustrates an exemplary messaging interface according to an embodiment.

FIG. 6F illustrates an exemplary bidding interface according to an embodiment.

### DETAILED DESCRIPTION

Hydrocarbon-bearing formations are non-homogenous. Based on its geographical location, each oil well may have unique associated problems such as, lost circulation, pipe sticking, hole deviation, pipe failures, borehole instability, mud contamination, formation damage, hole cleaning, shallow gas and hydrogen sulfide-bearing formation. Typically, information on solving these problems is proprietary and best practices are not shared between companies.

Additionally, specific oilfield equipment or services may be required to resolve or mitigate problems encountered in the oilfield (or oil field). These problems can be exacerbated by not having timely access to appropriate equipment and services. Although engineers and other technical staff provide input in the purchasing of oilfield equipment and services, due to the competitive and proprietary nature of the oilfield industry, the rationale behind certain purchases and the selection of reliable and cost effective vendors is usually not shared between companies and, at times, between engineers within the same company. The selection of oilfield equipment and services is a challenging task for companies involved in oil and gas production. In these companies, centralized procurement or purchasing departments coordinate most purchases with input from relevant business users. Frequently, several complex considerations have to be factored into decision-making process. An incorrect purchasing decision not only affects oil and gas production but it may also have harmful effects on the environment. Although there are several websites and software programs that facilitate purchasing of specific equipment and services, there is no mechanism available for making purchasing decisions based on the unique challenges or problems encountered at a specific oilfield location.

This disclosure pertains to systems, methods, and computer readable media for delivering location-triggered oilfield content. According to an embodiment, a user can obtain content that is customized to addressing a problem or a “challenging task” (or “challenge task”) encountered at an oilfield located in a specific geographical location. The user can associate geographical identification metadata or geotags with the challenge task in order to access, share and leverage “tribal knowledge”—that is, previously unwritten and unshared knowledge pertaining to overcoming or resolving the challenge task. The user may be able to search through a repository that contains content related to a plurality of challenge tasks encountered at the specific oilfield, receive recommendations for overcoming those specific challenges and acquire or solicit bids for equipment and services associated with the recommendations. Therefore, by discovering, anticipating and understanding various challenge tasks, the user can make informed, timely and cost-effective purchasing decisions.

In one embodiment, a computer-implemented method includes the steps of displaying, in a digital map, one or more oilfields located at a user-determined geographical location, wherein map coordinates associated with each of the oilfields can be predetermined; creating a digital tag for a challenge task encountered in at least one oilfield located at the geographical location; and dynamically displaying digital content responsive to the challenge task encountered in the oilfield. The digital content may be displayed in a first area of a suitable display device. The information associated with the creation of the digital tag can be acquired and analyzed prior to creating the digital tag. The digital tag can include information associated with the challenge task. For instance, the digital tag information can include information on the oilfield, the geographical location, and a description of the challenge task. The method further includes implementing a drag-and-drop geotagging operation, wherein the geotagging operation can include embedding geographical identification metadata to the digital tag and selecting, dragging and dropping the digital tag at the predetermined map coordinates associated with the oilfield.

The information associated with the challenge task can be analyzed and correlated with customized digital content that is tailored to resolve the challenge task encountered in the location. The digital content may be previously geotagged in stored in a computer readable medium. The digital content may include solutions and optimization techniques specific to the geographical location. The optimization techniques may include a recommended solution, a general technology best practice, a best practice for the geographical location and a lesson learned. The correlated digital content may be displayed on the display device. A feedback mechanism for delivering information associated with a viability of the displayed content may be implemented. One or more users may be allowed to provide feedback on the displayed content. Information on the feedback providers may be collected. Predetermined information on a feedback provider may be displayed or shared with other users. The predetermined information may include, for example, the feedback provider's job title, years of oilfield experience and a seniority function.

The method can further involve dynamically displaying information on one or more oilfield services and equipment available for acquisition in the geographical location. The information on the oilfield services and equipment is displayed in a second area of the display device. The step of displaying the information further comprises enabling an authenticated vendor to input information on the oilfield services and equipment available for acquisition, wherein the information comprises information on a geographic location of the one or more oilfield services and equipment and dynamically determining whether the oilfield services and equipment are available for acquisition in the geographical location where the oilfield is located. The vendor can be allowed to upload digital media, such as, a brief digital video, text, photographs and messages comprising information on the one or more services and equipment. The video can be displayed and played back using an embedded digital media player. The method further involves providing a bidding interface for the acquisition of the services and equipment in the geographical location. The bidding interface can be integrated with a vendor messaging interface and a vendor payment interface.

The techniques disclosed herein can be implemented on any number of electronic devices such as, mobile phones, personal data assistants (PDAs), as well as personal computer, laptop and tablet computer systems. For clarity, not all features of an actual implementation are described. It will of course be appreciated that in the development of any actual implementation (as in any development project), numerous decisions must be made to achieve the developers' specific goals (e.g., compliance with system- and business-related constraints), and that these goals will vary from one implementation to another. It will be further appreciated that such development effort might be complex and time-consuming, but would nevertheless be a routine undertaking for those of ordinary skill having the benefit of this disclosure.

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation, numerous specific details are set forth in order to provide a thorough understanding of the inventive concepts. As part of the description, some structures and devices may be shown in block diagram form in order to avoid obscuring the invention. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

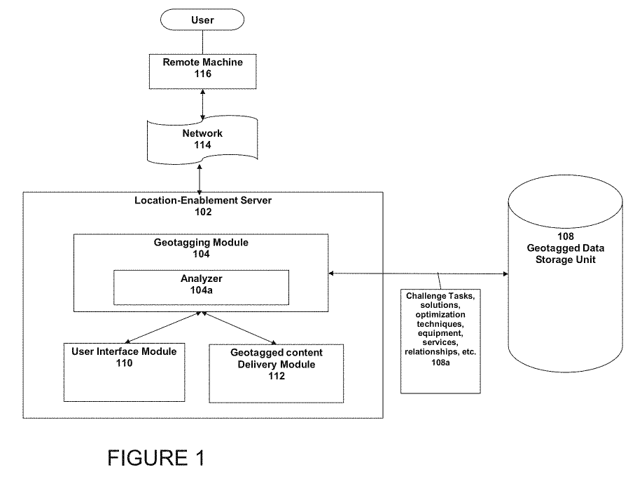

FIG. 1 is a diagram of one embodiment of a geotagging system for delivering location-triggered oilfield content 100. The system 100 can include a location-enablement server 102 and a geotagged data storage unit 108 for storing geotagged data. The location-enablement server 102 can be accessible to any number of user machines and users through a network 114. The network 114 can be local area network (LAN), such as an intranet (or private domain) within a company, a wide area network (WAN), such as the Internet or similar communication system. The network 114 can include any number of networking and computing devices including any number of wired and wireless devices. The network may include connections, such as wire, wireless communication links, or fiber optic cables.

The location-enablement server 102 includes a geotagging module 104, a user interface module 110, a geotagged content delivery module 112 and similar components. This division of functionality is presented merely by way of example for the sake of clarity. One skilled in the art would understand that the functionality described could be combined into a monolithic component or sub-divided into any similar combination of components.

The user interface module 110 can interface with any of the other modules or components of the location-enablement server 102 including the geotagging module 104 and the geotagged content delivery module 112 to generate an interface to be utilized by a user. The term user can include, without limitation, oil and gas engineers, an oilfield operator, oil and gas purchasing and other supply chain personnel, oilfield equipment or services vendor, students, and any other oil and gas industry personnel and service providers.

The user interface module 110 can provide a graphical user interface or command line interface for remote machine 116 over the network 114. Any number of remote machines may be used to access the user interface module 110. The user interface module 110 can be a web-based interface such as a web server or similar specialized interface to interact with the client on remote machines. Remote machine 116 can be any type of computing device including desktop computers, laptop computers, handheld computers or similar computing device. The user interface provided by the user interface module 110 can be accessed by general purpose browsers or specialized applications. The user interface module 110 interfaces the location-enablement server 102 with the remote machines 116 by making available the functionality of the geotagging module 104 and the geotagged content delivery module 112.

Instructions for the geotagging software and geotagged data files may be stored in the geotagged data storage unit 108 and loaded into memory for execution by a processor (not shown). The processor may include one or more processors, microprocessors, or processing logic that may interpret and execute instructions for geotagging. A communication unit, such as modem or network adapter (not shown), may include one or more devices used to transmit and receive data. The geotagged data storage unit 108 can be a local storage unit or a remote storage unit. The geotagged data storage unit 108 may be a database, a magnetic storage unit, optical storage unit, solid state storage unit or similar storage unit. The geotagged data storage unit 108 can be a monolithic device or a distributed set of devices.

The geotagging module 104 may further include an analyzer 104a. The analyzer 104a can be configured to automatically detect and analyze data received from a user device (not shown) related to oilfield requirements specific to an oilfield location. The analyzer can further continually and automatically retrieve and analyze geotagged oilfield requirements data 108a stored in the geotagged data storage unit 108, in a real time or substantially real time basis. If the user-inputted oilfield requirement is not found in the geotagged data storage unit 108, it can be used to create a new geotagged requirements data record 108a. The analyzer 104a may be configured to determine whether one or more geotagged requirements have associated geotagged solutions data. The geotagged solutions data can include, for example, oilfield solutions, optimization techniques, equipment or services that can satisfy the geotagged requirements. When one or more geotagged solutions data is identified as being responsive to the geotagged requirements, the analyzer 104a can automatically assign an indicator or marker to the identified geotagged solutions data. The marker-assigned geotagged solutions data may be automatically transmitted to the geotagged content delivery module 112 for display by a user device.

The geotagged content delivery module 112 interfaces with the analyzer 104a. The geotagged content delivery module 112 can create custom analytical reports, notifications, and alerts on geotagged solutions that satisfies a geotagged requirement. These reports, notifications and alerts can be displayed upon user request (via the user interface module 110). These reports, notifications and alerts can also be in the form of automated messages (which may also be generated by a separate messaging module).

The system 100 may further connect to or integrate with other hardware and software modules. For example, in one embodiment, the system 100 may be configured to prompt the user to provide a random security or authentication code. The random security code may be generated by the system 100, by a separate security dongle, or in another manner. The security code may be provided to the system 100 may be keyed into the user interface (e.g., by a user), or may be received in another manner prior to allowing the user access to the system. Access may be allowed to the system 100 only if it can authenticate the user's credentials (such as, the user id, email id and the transmitted security code). Access to the system 100 can be denied if the user credentials are not authenticated. In other embodiments, the system 100 may interface with a report generation and tracking module, a payment (for example, a credit card) system, a problem tracking module, a failure analysis and metrics module, a vendor sales metrics funnel display module, user activity logs and the like.

Those of ordinary skill in the art will appreciate that other internal hardware or peripheral devices, such as flash memory, equivalent non-volatile memory, or optical disk drives and the like, may be used in addition to or in place of the hardware described. Moreover, the system may take the form of any of a number of different data processing systems including client computing devices, server computing devices, a tablet computer, laptop computer, telephone or other communication device, a personal digital assistant (PDA), or the like. In some illustrative examples, the system may be a portable computing device configured with flash memory to provide non-volatile memory for storing operating system files and/or user-generated data, for example. Essentially, the system may be any known or later developed data processing system without architectural limitation.

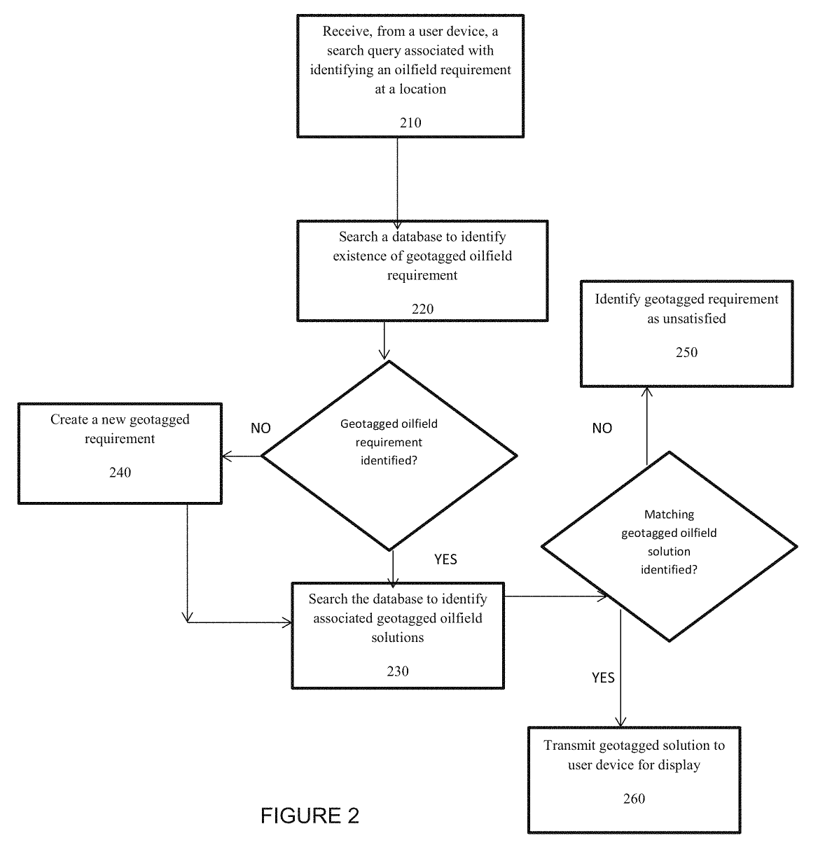

Referring now to FIG. 2, a method 200 for delivering location-triggered oilfield content using the geotagging system is shown at a high level in flow chart form, in accordance with one embodiment. In certain embodiments, the user may be required to create an account on the system prior to accessing the geotagging system. The user may be prompted to provide his (or her) name, professional experience, an employer/educational institution name, telephone number and an email address associated with a company or institution, such as, an educational institution. Alternately, the user can use his social media profile (such as, his profile on LinkedIn) to create an account. In certain embodiments, a security or authentication code (which may be generated by the system) may have to be input by the user before he is allowed to create a user account.

Now referring back to FIG. 2, a search query from a user device may be received 210. The search query can be related to an oilfield requirement at a specific oilfield location. As used herein, in certain embodiments, a requirement comprises a challenging task or problems, issue, setback or difficulty encountered in an oilfield. For example, the requirement comprises a problem relating to a stuck pipe or lost circulation in a drilling operation or a problem during a completion, production and work over phase of a production operation at a particular geographical location, or a problem at a facility, reservoir or the formation at a particular geographical location. In other embodiments, a requirement comprises an optimization technique employed at the oilfield location. In yet either embodiment, a requirement comprises oilfield equipment and services required to implement the optimization techniques or solutions to the problems. In yet another embodiment, the requirement comprises all of the above, namely, a challenging task encountered at an oilfield location, an optimization technique employed at the oilfield location and oilfield equipment and services.

The method involves searching a database of geotagged oilfield requirements to determine if the oilfield requirement exists in the database 220. The term “geotagged oilfield requirement” implies that the requirement has been associated with geographical identification metadata linking the requirement with a specific oilfield location. Search techniques known in the art, such as, keyword searching may be employed to identify the existence of geotagged oilfield requirements. If a geotagged requirement exists in the database, the database is searched to identify if geotagged oilfield solutions associated with the geotagged oilfield requirement are found for the oilfield location 230. However, if an existing geotagged oilfield requirement is not found in the database, a new geotagged oilfield requirement may be created 240. The database may be then searched to determine if an associated geotagged solution for the newly created geotagged oilfield requirement is found 230. The database may include data identifying relationships between the geotagged oilfield requirements and associated geotagged solutions. Searching the database for a geotagged oilfield solution may involve the step of dynamically searching the database for one or more geotagged solutions to determine if they are associated or related to corresponding geotagged oilfield requirements. If a geotagged oilfield solution is located, it can be dynamically identified for transmission and transmitted to a user device for display 260. However, if a geotagged oilfield solution is not located, an entry can be made in the database to identify the geotagged oilfield requirement as being unmet or unsatisfied 250. The user or system administrators can send invitations to other users, who may be experts in the oilfield industry or who may have previous experience in resolving the requirement, to provide a solution specific to the oilfield location.

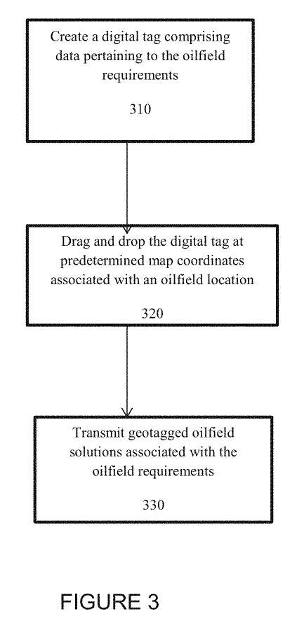

FIG. 3 illustrates an exemplary method for creating a geotagged oilfield requirement to deliver geotagged oilfield solutions. First, the system can automatically create a digital tag or pin 310. The digital tag comprises data pertaining to an oilfield requirement. For instance, a digital pin may be created for a challenging task, such as, lost circulation, encountered at an oilfield in a specified geographical location (for example, at the Bakken oil fields in Northern America). Digital tags are digital media that enable the collection and sharing of oilfield data between the geotagging system and the various technologies that rely upon this data, such as, analytics platforms, service provider systems, and the like. Next, the digital tag may be deployed to facilitate a location-triggered analysis 320. The deployment may involve displaying a digital geographical map on a user display. The deployment may further involve performing a drag-and-drop operation to drop the digital tag at map coordinates associated with the oilfield location. The map coordinates associated with plurality of oilfield locations may be previously determined and stored in a database. When the digital tag is dropped at its desired map coordinates, a computer algorithm dynamically matches and transmits one or more customized, geotagged oilfield solutions that are responsive to the geotagged requirement for display in the user device 330.

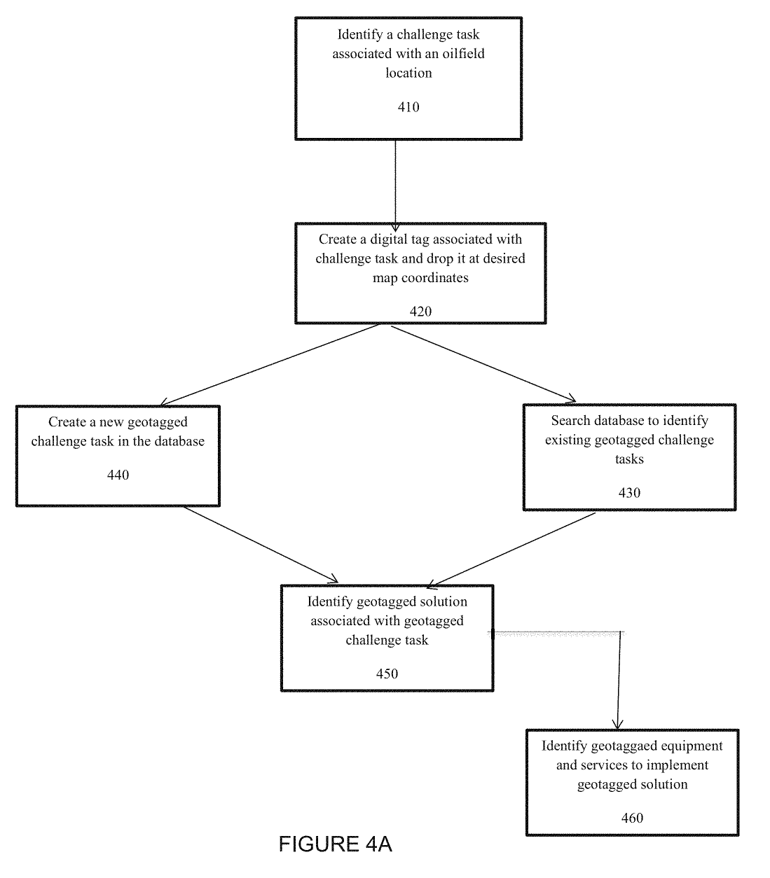

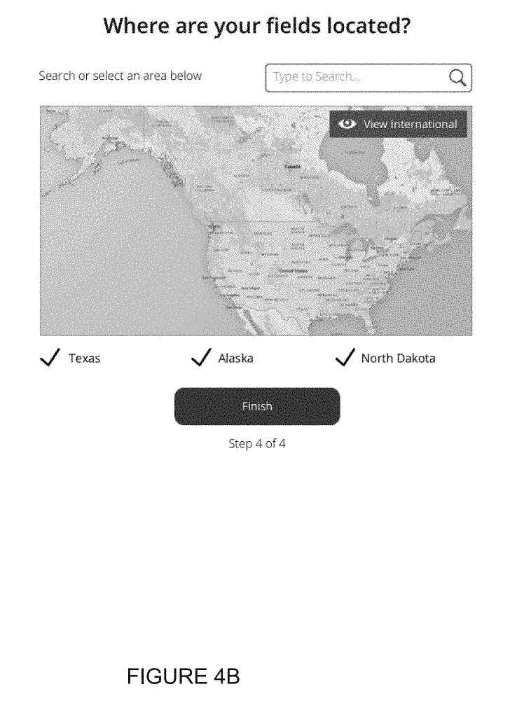

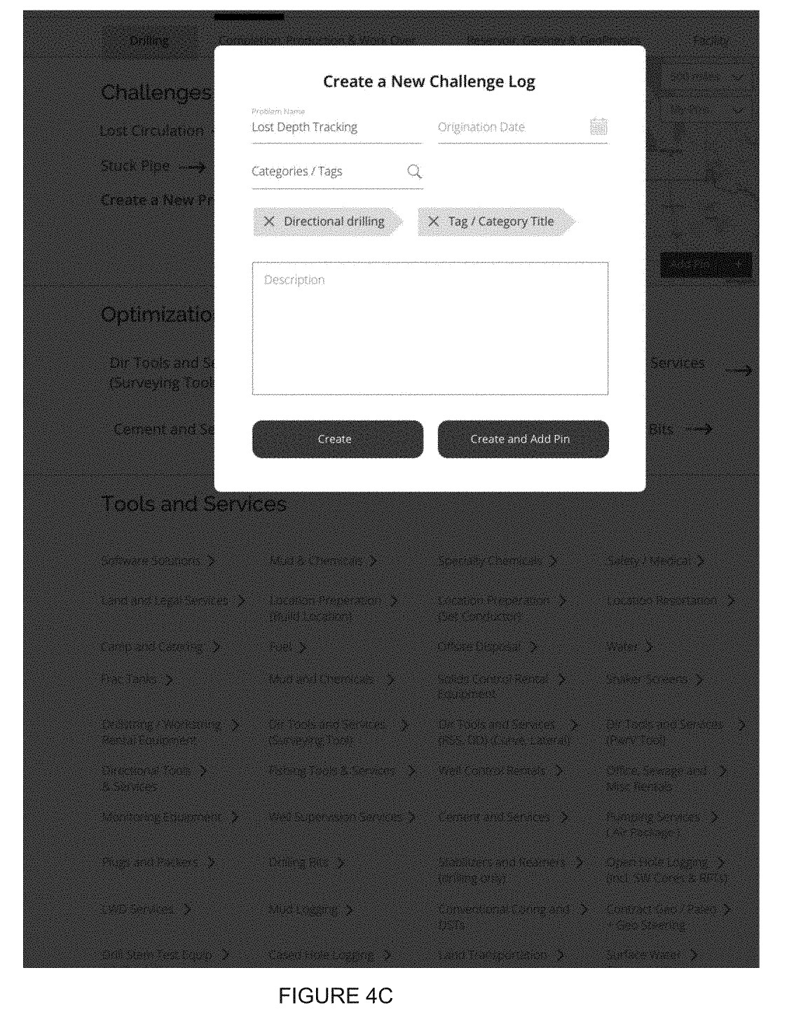

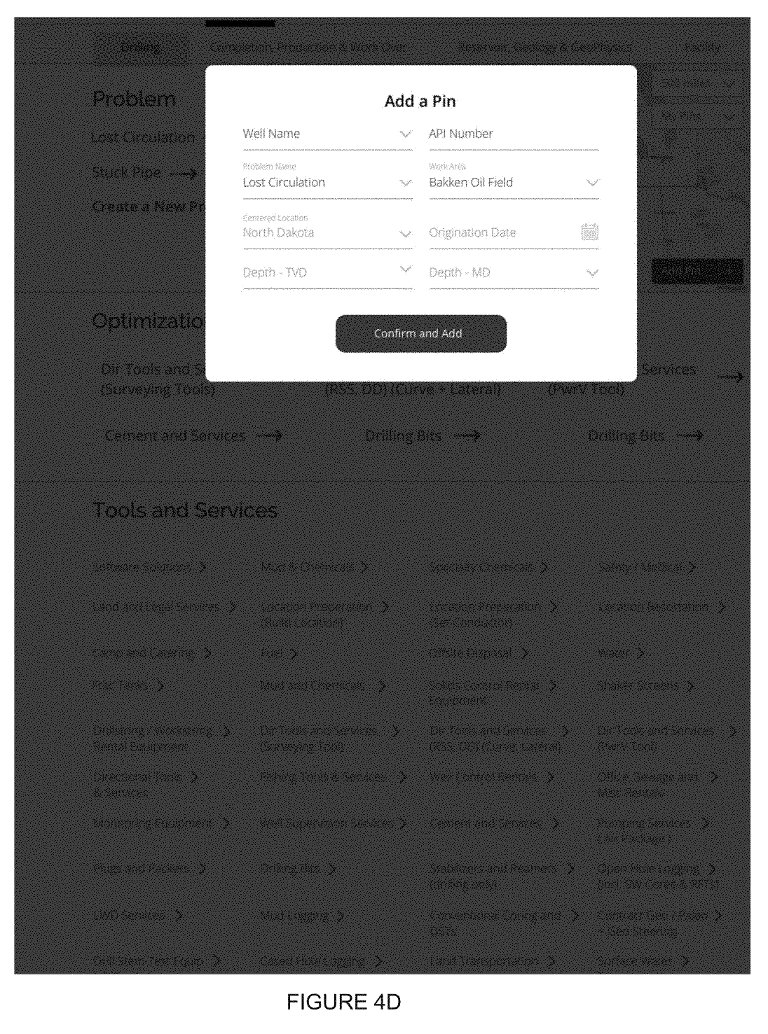

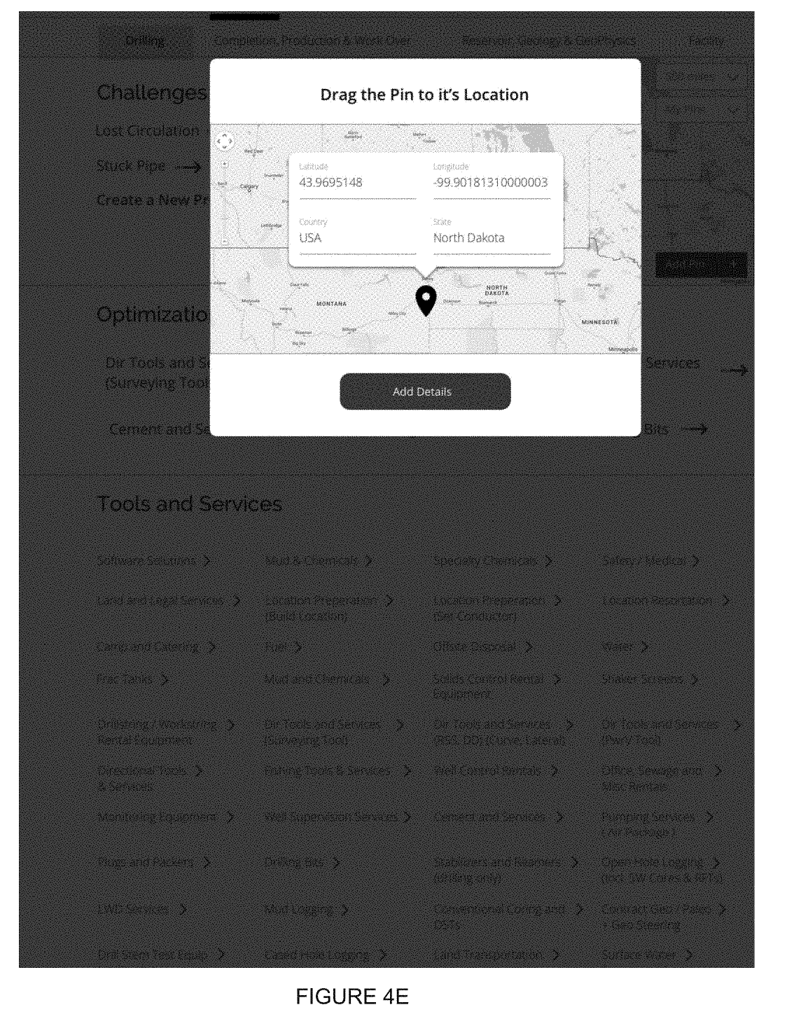

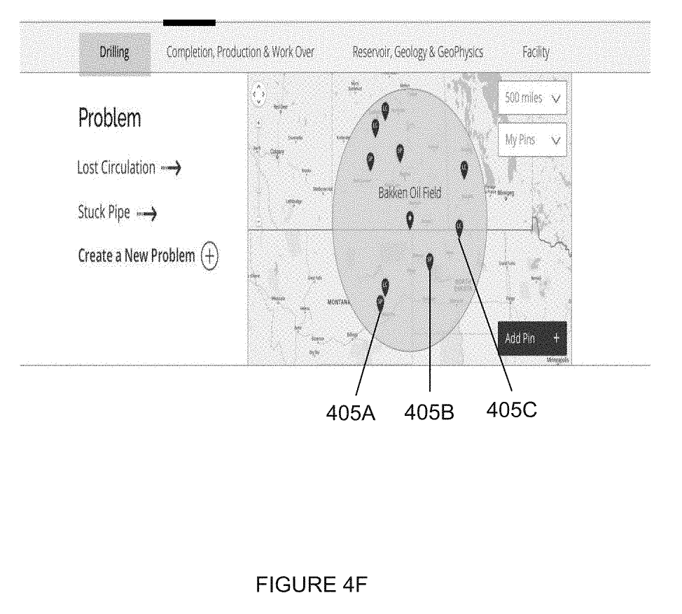

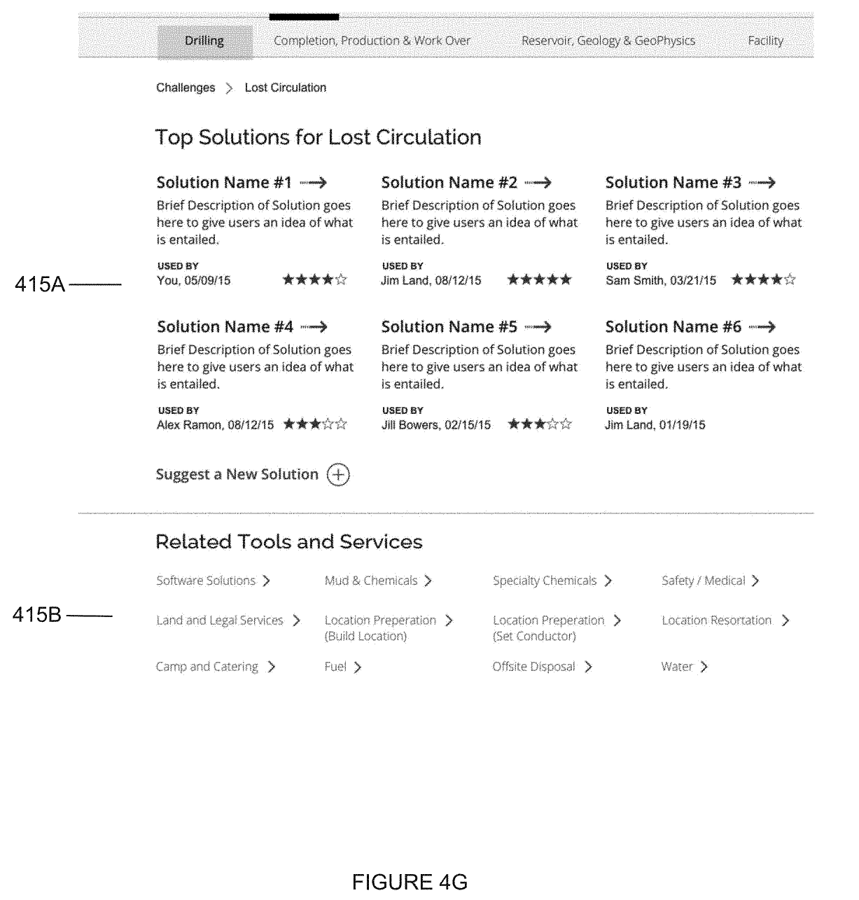

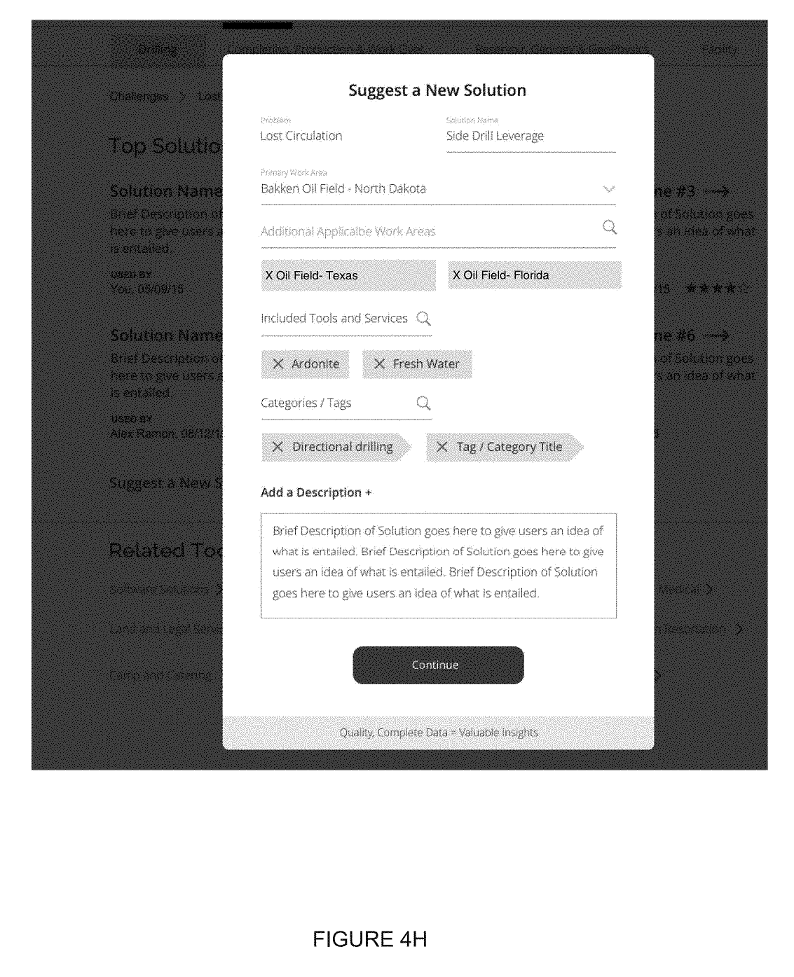

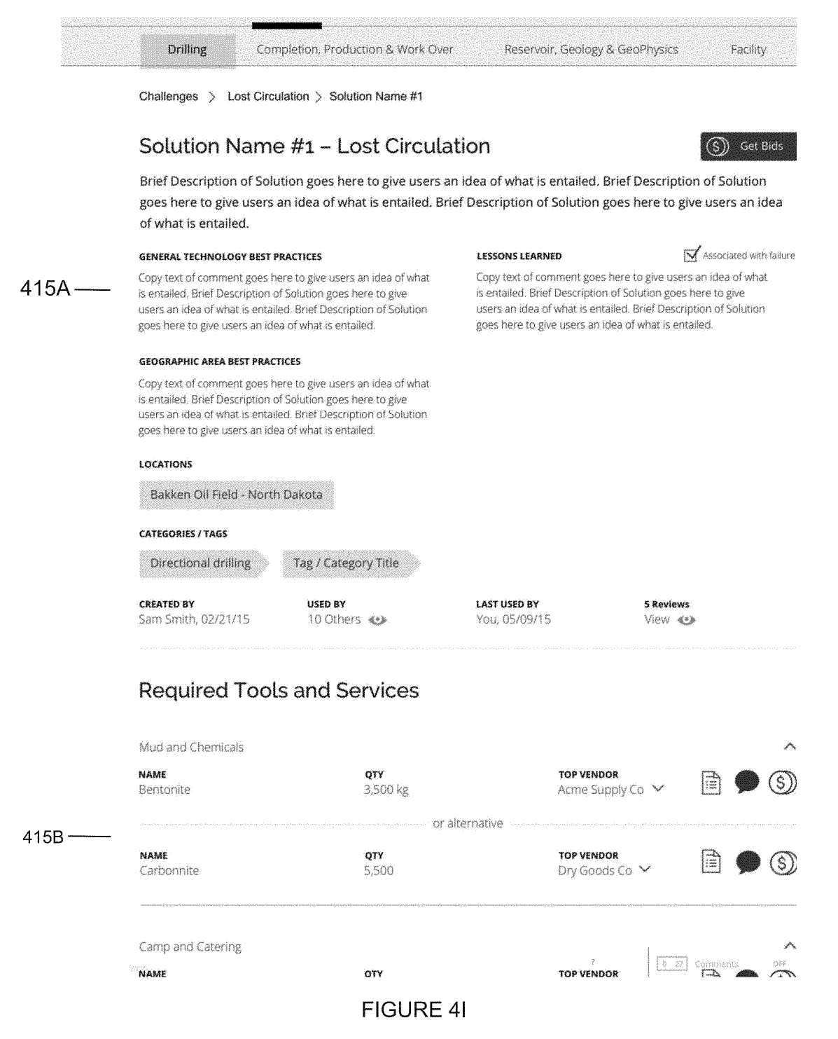

FIG. 4A illustrates an exemplary method for delivering location-triggered oilfield content. The method involves identifying a requirement comprising an oilfield problem or a challenge task at a location 410. The user may be initially required to identify a location of the oilfield(s) on a digital map displayed on a user device. An exemplary display is illustrated in FIG. 4B. As shown, using the user display, the user can identify one or a plurality of locations, for example, Texas, Alaska and North Dakota in the United States of America, to display a geographical map of the identified locations. For instance, in response to the selection of the geographical location, the geotagging system dynamically retrieves and displays the Bakken oilfields located in North Dakota and Montana on the digital geographical map. The map coordinates associated with each of the oilfields may be predetermined. The map coordinates may be stored in a computer-readable storage medium. The user can also select other oilfields located around the globe. Next, the user may create a log for the challenge task using the user display. An exemplary display for a challenge log is illustrated in FIG. 4C. As shown, the user can provide a problem name, its origination date and briefly describe the problem.

Next, referring back to FIG. 4A, the user can create a digital pin or tag for the logged challenge task at the oilfield 420. The user can then drag and drop the digital tag at a desired oilfield location on a geographical map displayed on a user device to geotag the challenge task 420. FIG. 4D illustrates an exemplary display for adding a digital pin or tag according to an embodiment. FIG. 4E illustrates an exemplary display for dragging the digital pin or tag to predetermined/desired map coordinates according to an embodiment.

Referring again to FIG. 4A, the user can also search a database to determine if the geotagged challenge task already exists in the database 430. The database may be in the public domain or it may be limited to authorized users (such as, in a particular oilfield company). The geotagged challenge task may be previously logged or entered into the database by a prior user of the geotagging system. If the geotagged challenge task does not exist, the user can create a new entry for a geotagged optimization technique 540 the user can create a new entry for a geotagged challenge task 440. FIG. 4F illustrates an exemplary display for a user interface for identifying and geotagging a challenge task. As shown, a plurality of geotags 405A, 405B, 405C, etc. have been dropped at locations corresponding to an identified challenge task at specific location in an oilfield (here, the Bakken Oil Field).

Referring back to FIG. 4A, the identification/creation of the geotagged challenge task causes a computer algorithm to identify one or more geotagged solutions associated with the geotagged challenge task 450. Typically, solutions to geotagged challenge tasks are already logged and entered into the database by previous users of the system. These solutions may be geotagged to specific locations by further associating them with geographical identification metadata. Each geotagged oilfield solution may be associated with or related to a geotagged oilfield challenge task in the database.

Responsive to the identified solutions, the system can dynamically identify equipment and/or services required to implement the geotagged solutions 460. The equipment and services may be previously geotagged and inputted into the system by a vendor. The vendor can also define an association or relationship between a geotagged solution and the vendor-provided equipment and/or services. The identified equipment and services may be transmitted to and displayed on the user device.

FIG. 4G illustrates an exemplary display for the solutions associated with a challenge task and related tools and services according to one embodiment. As shown, the solutions associated with the challenge task, namely, lost circulation in the oil well, can be displayed on a first area 415A of the display. Conveniently, any related equipment/tools and services can be displayed on a second area 415B of the display in close proximity to the displayed solutions. A plurality of solutions may be provided and displayed. Associated with each solution, the system can display a name associated with a person who last used the solution and a date when the solution was used. User ratings associated with each of the solutions may also be displayed. The user ratings may be provided by independently verifiable users of the geotagging system. In certain embodiments, only users who have a predetermined level of expertise in the oil and gas industry may be allowed to rate the solutions.

If a geotagged challenge task or solution is not found in the database, a user can add a new solution that satisfies the problem/challenge task. In the case of non-existing challenge task or solution, the user may be provided with an option to fill out an entry form describing in detail the challenge task or solution they wish to input. This step can be done hours or days after the best solution is identified, recommended or logged by other users or the problem origination user. The system can also provide an interface for the user to post his query in the public domain to obtain and invite feedback from other users. FIG. 4H illustrates an exemplary display for adding a new solution. As illustrated, the new solution may be associated with a problem/challenge task at a primary oilfield (or work area). For example, the user may provide a solution for lost circulation in the Bakken oil field. If appropriate, the user can also indicate secondary locations in other geographical areas where the solution may be applicable. If available, the user can identify related equipment and services for implementing the solution.

FIG. 4I illustrates an exemplary display for geotagged solutions associated with a challenge task and related tools and services in an expanded view. As shown, for each solution, the user can be provided with information on a general technology best practice, a best practice for the geographical location and contextual lessons learned. Data corresponding to general technology best practice, a best practice for the geographical location and lessons learned may be stored in the database and transmitted to the user device upon detecting a match with a geotagged challenge task. The system can further store and display information on the number of users that have used the solution. A solution that has been identified as being used by a plurality of users can be marked and designated as a “top” solution in the database. The solution may be illustrated in a top half area of the display 415A while the related or required equipment and services may be provided in a bottom half area of the display 415B. The names of the vendors who provide the geotagged equipment or services can be displayed in proximity to the associated geotagged equipment or service. The system facilitates direct communication of the user with the vendors through integrated messaging and bidding modules. The user can directly request a bid from vendors. The user can also send the vendors text messages, purchase orders or other documents requiring additional information.

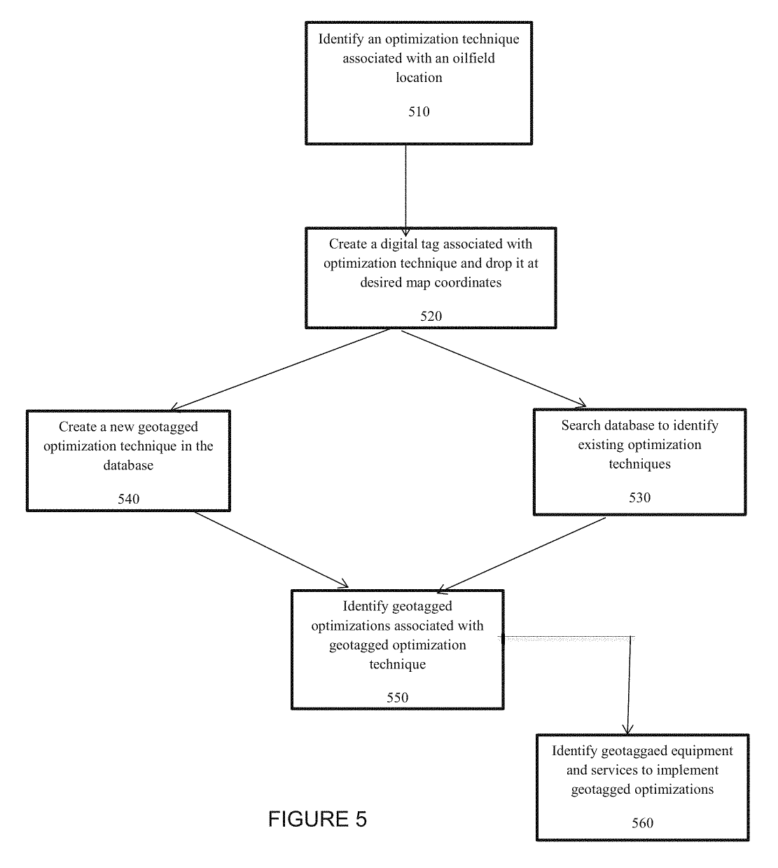

FIG. 5 illustrates an exemplary method for delivering location-triggered oilfield content. The method involves identifying a requirement comprising information on an optimization technique or best practice solution employed at an oilfield location 410. The user may be initially required to identify a location of the oilfield(s) on a digital map displayed on a user device as described earlier with reference to FIG. 4B.

Next, referring back to FIG. 5, the user can create a digital pin or tag for the optimization technique at the oilfield 520. The user can then drag and drop the digital tag at a desired oilfield location on a geographical map displayed on a user device to geotag the optimization technique 520.

The user can also search a database to determine if the geotagged optimization technique already exists in the database 530. The database may be in the public domain or it may be limited to authorized users (such as, in a particular oilfield company). The geotagged optimization technique may be previously logged or entered into the database by a prior user of the geotagging system. The previously geotagged optimization techniques may include the most common or trending optimization techniques in the specified location. If the geotagged optimization technique does not exist, the user can create a new entry for a geotagged optimization technique 540.

The identification/creation of the geotagged optimization technique causes a computer algorithm to identify geotagged optimization data or optimizations associated with the geotagged optimization technique 550. Typically, the optimizations are already logged and entered into the database by previous users of the system. These optimizations may be geotagged to specific locations by further associating them with geographical identification metadata. Each geotagged optimization may be associated with or related to a geotagged optimization technique task in the database. The user can further be provided with information on a general technology best practice, a best practice for the geographical location and contextual lessons learned.

Responsive to the geotagged optimizations, the system can further dynamically identify equipment and/or services required to implement the geotagged optimizations 560. The equipment and services may be previously geotagged and inputted into the system by a vendor. The vendor can also define an association or relationship between a geotagged optimization and the vendor-provided equipment and/or services. The identified equipment and services may be transmitted to and displayed on the user device. The system facilitates direct communication of the user with the vendors of optimizations through integrated messaging and bidding modules. The user can directly request a bid from vendors or send the vendors text messages, purchase orders or other documents requiring additional information.

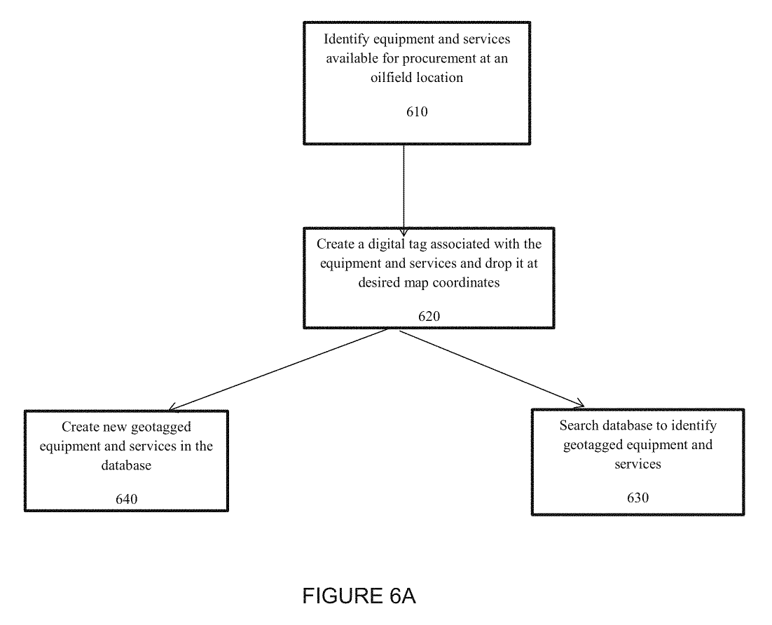

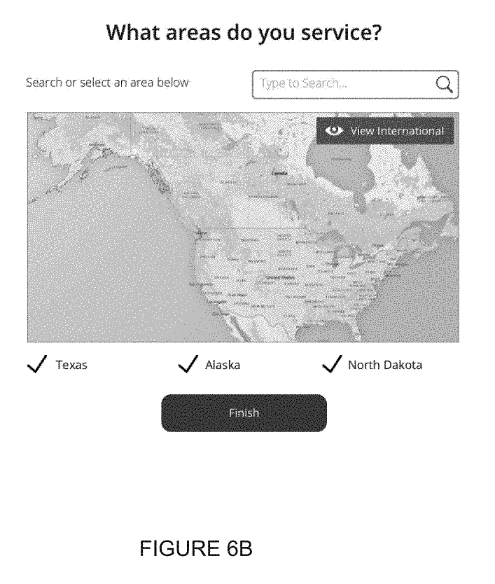

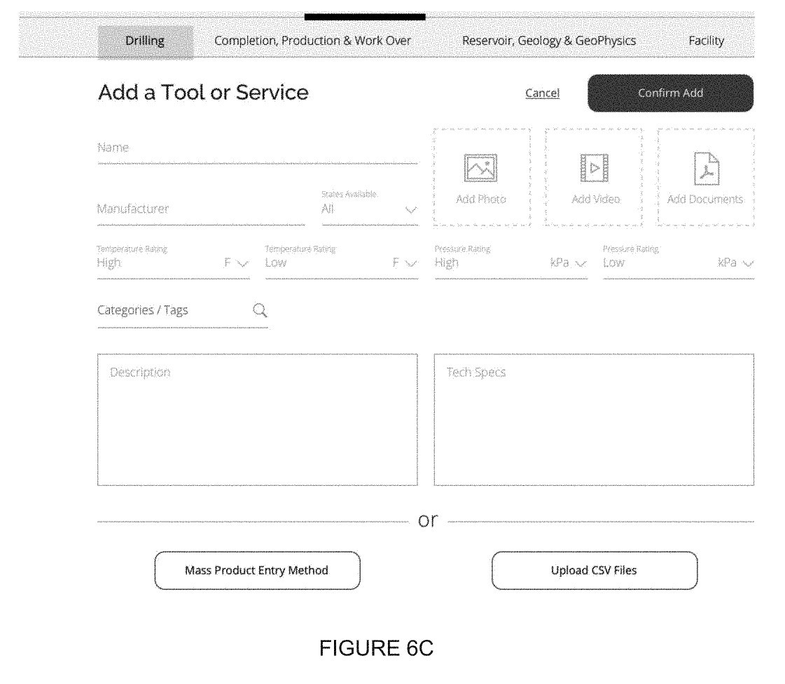

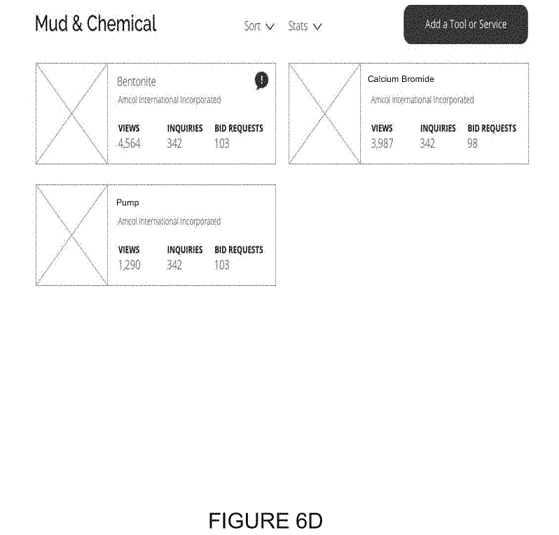

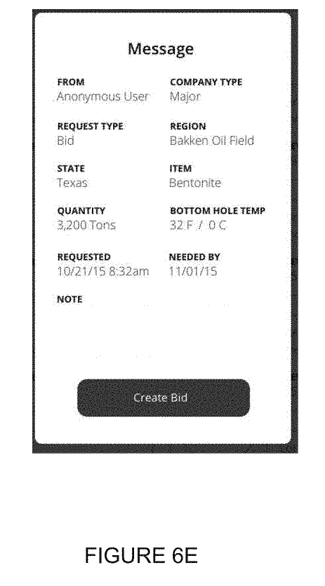

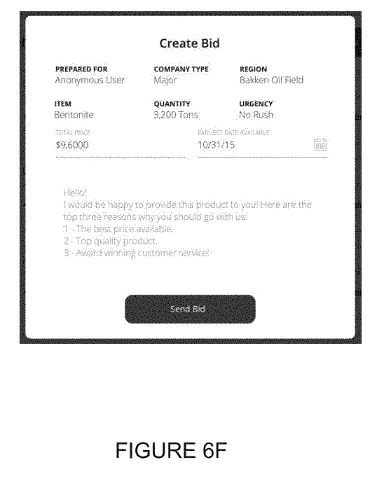

FIG. 6A illustrates an exemplary method for enabling vendors to deliver location-triggered requirements at an oilfield location. The requirements include identifying information on equipment and services available for procurement at an oilfield location 610. The vendor may be initially required to identify a location of the oilfield(s) that can be serviced on a digital map displayed on a user device. An exemplary display is illustrated in FIG. 6B. As shown, using the user display, the user can identify one or a plurality of locations, for example, Texas, Alaska and North Dakota in the United States of America, to display a geographical map of the identified locations.

Next, referring back to FIG. 6A, the vendor can create a digital pin or tag for the equipment and services that can be delivered to the oilfield 620. In one embodiment, a vendor may be allowed to create a digital tag only if the equipment is within a predetermined distance (for example, within 500 miles) of the oilfield (or if the services can be delivered within a particular timeframe, such as, within 24 hours from when an order is placed). This ensures that the equipment or services may be delivered to the oilfield in a timely manner. Next, the vendor can drag and drop the digital tag at a desired oilfield location on a geographical map displayed on a user device to geotag the equipment and services 620.

The vendor can also search a database to determine if the geotagged equipment and services previously exists in the database 630. The database may be in the public domain or it may be limited to authorized users (such as, in a particular oilfield company). The geotagged equipment and services may be previously logged or entered into the database by a prior vendor or by the same vendor. If the geotagged equipment and services does not exist, or if the vendor is able to provide an alternative to another vendor's equipment and/or services, the vendor can create a new entry for the geotagged equipment and services 640.

FIG. 6C illustrates an exemplary display for adding a new equipment or service. As shown, exemplary vendor, ABC International Incorporated can associate its supplied chemical or product, for example, “bentonite”, with a challenge task (for example, directional drilling) at an oilfield in a specified location. The vendor can also provide product and technical specifications. The vendor can also upload photographs, videos and other documents pertaining to the geotagged equipment and services. Alternately, the vendor may copy any media file pertaining to the geotagged equipment and services to a designated location on the user display.

FIG. 6D illustrates an exemplary interface for geotagged equipment and services. As shown in FIG. 6D, the vendor may also be able to conveniently access enquiries and bid requests for the geotagged equipment from a convenient user interface.

The system facilitates direct communication of the user with the vendors of optimizations through integrated messaging and bidding modules. Exemplary messaging and bidding interfaces are displayed in FIGS. 6E and 6F. The user can directly request a bid from vendors or send the vendors text messages, purchase orders or other documents requiring additional information. The embodiments enable a vendor to associate their equipment and services with geotagged challenge tasks, optimization techniques and solutions and, by geotagging their equipment and services, to specify the region or area they can provide the equipment and services. A service provider or vendor can also suggest a solution to a listed problem and provide information on optimization techniques. As described herein, along with the entries of solutions and optimization techniques, they are provided the option to link appropriate services and equipment. Thus, the vendors have an opportunity to elaborate on the benefits of their services and equipment as well as to pre-qualify a client for an equipment or service they might be interested in.

The one or more embodiments disclosed herein allow oilfield users to easily access customized, high-value information regarding engineering challenges and solutions. The techniques disclosed herein are further designed to seamlessly work with acquisition of services and tools associated with the proposed solutions with lessons learned in context. Therefore, the embodiments provide a comprehensive solution for oilfield users from discovery to acquisition of services.

Using the embodiments, any a user, in a company or organization who learns about a geotagged solution, or geotagged available product/service, implementation best practices and lessons learned, may be able to drive quality decision making while reducing waste and inefficiencies. This will also help operators prevent the brain drain problem plaguing the oil and gas industry, enabling them to capture the knowledge and helping make it available at the right time at the right place in context to help drive quality decision making. This can help oil and gas operators become more efficient and can immensely expedite the learning curve for new and cross functional oil and gas industry professionals, for instance, engineers, supply chain and other functions. The techniques disclosed herein also facilitate in a green work environment by reducing the amount of paper used for printing quotes, spreadsheets and such independent non connected silos of information storage systems.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. No limitation with regard to the described aspects or embodiments of the present invention is intended. Many modifications to the depicted embodiments may be made without departing from the spirit and scope of the present invention. For example, embodiments of the invention may be modified for use in healthcare industry, home improvement industry, finance industry and software industry. Accordingly, the foregoing description is intended to be illustrative rather than restrictive. The invention described herein is defined by the appended claims and all changes to the invention that fall within the meaning and the range of equivalency of the claims are embraced within their scope.

While the geotagging systems and methods of are described in terms of “comprising,” “containing,” or “including” various components or steps, the wave vibrator and methods also can “consist essentially of” or “consist of” the various components and steps. Also, the terms in the claims have their plain, ordinary meaning unless otherwise explicitly and clearly defined by the patentee. Moreover, the indefinite articles “a”, “an”, and “the” as used herein and throughout the claims that follow are intended to include the plural references unless the context clearly indicates otherwise. Also, as used in the description herein, the meaning of “in” includes “in” and “on” unless the context clearly dictates otherwise. If there is any conflict in the usages of a word or term in this specification and one or more patent(s) or other documents that may be incorporated herein by reference, the definitions that are consistent with this specification should be adopted.

1. A computer-implemented method comprising:
creating, using a processor, a digital tag for a requirement associated with a geographical location, wherein the digital tag includes information associated with the requirement;
associating geographical identification metadata with the digital tag; and
dynamically displaying digital content responsive to a deployment of the digital tag at the geographical location.

2. The method according to claim 1, further comprising displaying a digital map, wherein one or more oilfields located at the geographical location are automatically displayed on the digital map.

3. The method according to claim 2, wherein the digital tag information further comprises information associated with the one or more oilfields.

4. The method according to claim 2, wherein the requirement is an oilfield requirement, and wherein the oilfield requirement is selected from the group consisting of a challenge task encountered in at least one of the oilfields, an optimization technique for at least one of the oilfields, one or more oilfield equipment and/or services required to resolve the challenge task or to implement the optimization technique, and combinations thereof.

5. The method according to claim 2, wherein deploying the digital tag comprises dragging and dropping the digital tag at map coordinates associated with at least one of the oilfields.

6. The method according to claim 4, further comprising analyzing, using the computer processor, the information associated with the challenge task to deliver the digital content, wherein the digital content is customizable for resolving the challenge task and implementing the optimization technique.

7. The method according to claim 6, wherein implementing the optimization technique comprises dynamically presenting a recommended solution, a general technology best practice, a best practice for the geographical location and a lesson learned.

8. The method according to claim 2, further comprising implementing, using the processor, a feedback mechanism for delivering information associated with a viability of the displayed digital content.

9. The method according to claim 8, further comprising displaying predetermined information on a feedback provider, wherein the predetermined information comprises the feedback provider's job title and years of oilfield experience.

10. The method according to claim 4, wherein the digital content is displayed in a first area of a display device.

11. The method according to claim 10, further comprising dynamically displaying information on the one or more oilfield equipment and/or services in a second area of the display device.

12. The method according to claim 11, further comprising dynamically determining whether the one or more oilfield equipment and/or services are available for acquisition in the geographical location.

13. The method according to claim 12, further comprising facilitating inputting of the information on the one or more oilfield equipment and/or services.

14. The method according to claim 12, further comprising providing a bidding interface for the acquisition of the one or more equipment and/or services.

15. The method according to claim 14, wherein the bidding interface is integrated with a vendor messaging interface and a vendor payment interface.

16. A non-transitory computer-readable medium on which is encoded program code for:
creating a digital tag for a requirement associated with a geographical location, wherein the digital tag includes information associated with the requirement;
associating geographical identification metadata with the digital tag; and
dynamically displaying digital content responsive to a deployment of the digital tag at the geographical location.

17. The non-transitory computer-readable medium according to claim 16, further comprising program code for:
displaying a digital map; and
automatically displaying one or more oilfields located at the geographical location on the digital map.

18. The non-transitory computer-readable medium according to claim 17, wherein the requirement is an oilfield requirement, and wherein the oilfield requirement is selected from the group consisting of a challenge task encountered in at least one of the oilfields, an optimization technique for at least one of the oilfields, one or more oilfield equipment and/or services required to resolve the challenge task or to implement the optimization technique, and combinations thereof.

19. The non-transitory computer-readable medium according to claim 18, further comprising program code for dynamically displaying information associated with the one or more oilfield equipment and/or services available for acquisition in the geographical location.

20. A system comprising:
at least one memory device with computer-readable program code stored thereon;
at least one processing device operatively coupled to the at least one memory device, comprising instruction code that is executable by the at least one processing device, and configured to:
creating a digital tag for a requirement associated with a geographical location, wherein the digital tag includes information associated with the requirement;
associating geographical identification metadata with the digital tag; and
dynamically displaying digital content responsive to a deployment of the digital tag at the geographical location.
